(19) United States
(12) Patent Application Publication
(10) Pub. No.: US 2012/0086597 A1
(43) Pub. Date: Apr. 12, 2012

(54) APPARATUS FOR PROCESSING SATELLITE NAVIGATION SIGNALS ADAPTIVELY, AND METHOD THEREFOR

(75) Inventors: Cheon-sig Sin, Daejeon-si (KR); Jae-Hyun Kim, Daejeon-si (KR); Sang-Uk Lee, Daejeon-si (KR)

(73) Assignee: ELECTRONICS AND TELECOMMUNICATIONS RESEARCH INSTITUTE, Daejeon (KR)

(21) Appl. No.: 13/270,696

(22) Filed: Oct. 11, 2011

(30) Foreign Application Priority Data
Oct. 12, 2010 (KR) 10-2010-0099487
Mar. 14, 2011 (KR) 10-2011-0022492

(51) Int. Cl. G01S 19/40

(52) U.S. Cl. 342/357.23

(57) ABSTRACT

Provided is a Global Navigation Satellite System (GNSS) receiver including: an RF signal processor to receive navigation signals; a signal level measurement unit to measure a signal level of each navigation signal; a signal processor to determine whether the navigation signal is a jamming signal or a normal signal based on the signal level, to perform quantization on the navigation signal determined as a jamming signal at a higher ratio than that subject to a normal signal to generate a digital signal, and to signal-process the digital signal; a compensator to identify a satellite ID of the navigation signal according to the result of the signal processing, and to create compensation information about the navigation signal according to the satellite ID; a controller to control the signal processor and the compensator; and a navigation solution processor to calculate a navigation solution of the navigation signal based on the compensation information.

### CROSS-REFERENCE TO RELATED APPLICATION

This application claims the benefit under 35 U.S.C. §119(a) of Korean Patent Applications No. 10-2010-0099487, filed on Oct. 12, 2010, and No. 10-2011-0022492, filed on Mar. 14, 2011, the entire disclosures of which are incorporated herein by reference for all purposes.

### BACKGROUND

1. Field

The following description relates to a technique of receiving satellite navigation signals, and more particularly, to a Global Navigation Satellite System (GNSS) receiver for processing satellite navigation signals adaptively according to the use environments of the satellite navigation signals when two or more GNSSs exist, and a method therefor.

2. Description of the Related Art

A Global Navigation Satellite System (GNSS) is used to detect the locations of targets using a plurality of satellites and terrestrial receivers and to provide visual information regarding the locations of the targets. Since the GNSS can provide accurate location information in the form of a visual screen, etc., the GNSS has been widely applied to various fields, such as navigation for terrestrial, oversea and air transportations, geodetic survey, hypsography, etc.

In general, a Global Positioning System (GPS) and a GLObal NAvigation Satellite System (GLONASS) have been widely utilized to acquire location information. However, GPS and GLONASS signals should be processed independently and have limitation in integrated processing. Furthermore, in the GPS and GLONASS, navigation frequencies that can be processed are limited to L1 or L2. Accordingly, a CTNSS receiver has been implemented to process only GPS and GLONASS signals.

Recently, various navigation systems, such as Galileo, COMPASS, and QZSS, other than GPS and GLONASS have been introduced and are expected to be widely used in the future, and accordingly a plurality of navigation frequencies will be provided. However, a conventional GNSS receiver has limitation in processing a plurality of navigation signals and also in sharing information between navigation systems that use the same navigation frequency or adjacent navigation frequencies. That is, the conventional GNSS receiver has low system availability, has limitation in providing accurate location information, and particularly, the conventional GNSS receiver does not support system extension. Moreover, since the conventional GNSS receiver is defenseless against jamming signals, the conventional GNSS receiver has difficulties in detecting their own locations when interference such as jamming between navigation signals is generated.

### SUMMARY

The following description relates to a Global Navigation Satellite System (GNSS) receiver which is capable of processing all navigation signals provided by a variety of GNSSs and of coping effectively with jamming, and a method therefor.

In one general aspect, there is provided a Global Navigation Satellite System (GNSS) receiver including: an RF signal processor configured to receive a plurality of navigation signals from a plurality of navigation satellites; a signal level measurement unit configured to measure a signal level of each of the navigation signals; a signal processor configured to determine whether the navigation signal is a jamming signal or a normal signal, based on the signal level of the navigation signal, to perform, if the navigation signal is determined to be a jamming signal, quantization on the navigation signal at a higher ratio than that subject to a normal signal to generate a digital signal, and to perform signal processing on the digital signal; a compensator configured to identify a satellite ID of the navigation signal according to the result of the signal processing, and to create compensation information about the navigation signal according to the satellite ID; a controller configured to control the signal processor and the compensator based on the results of the signal processing by the signal processor; and a navigation solution processor configured to calculate at least one navigation solution of the navigation signal based on the compensation information about the navigation signal.

In another general aspect, there is provided a method of processing a satellite navigation signal, including: receiving a plurality of navigation signals from a plurality of navigation satellites; measuring a signal level of each of the navigation signals; determining whether the navigation signal is a jamming signal or a normal signal, based on the signal level of the navigation signal, performing, if the navigation signal is determined to be a jamming signal, quantization on the navigation signal at a higher ratio than that subject to a normal signal to generate a digital signal, and performing signal processing on the digital signal; identifying a satellite ID of the navigation signal according to the result of the signal processing, and creating compensation information about the navigation signal according to the satellite ID; and calculating at least one navigation solution of the navigation signal based on the compensation information about the navigation signal.

Other features and aspects will be apparent from the following detailed description, the drawings, and the claims.

### BRIEF DESCRIPTION OF THE DRAWINGS

FIG. 1 is a diagram illustrating an example of a Global Navigation Satellite System (GNSS) receiver for processing navigation signals adaptively.

FIG. 2 is a flowchart illustrating an example of a method for processing navigation signals adaptively.

FIG. 3 is a flowchart illustrating an example of a process for controlling jamming signals.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

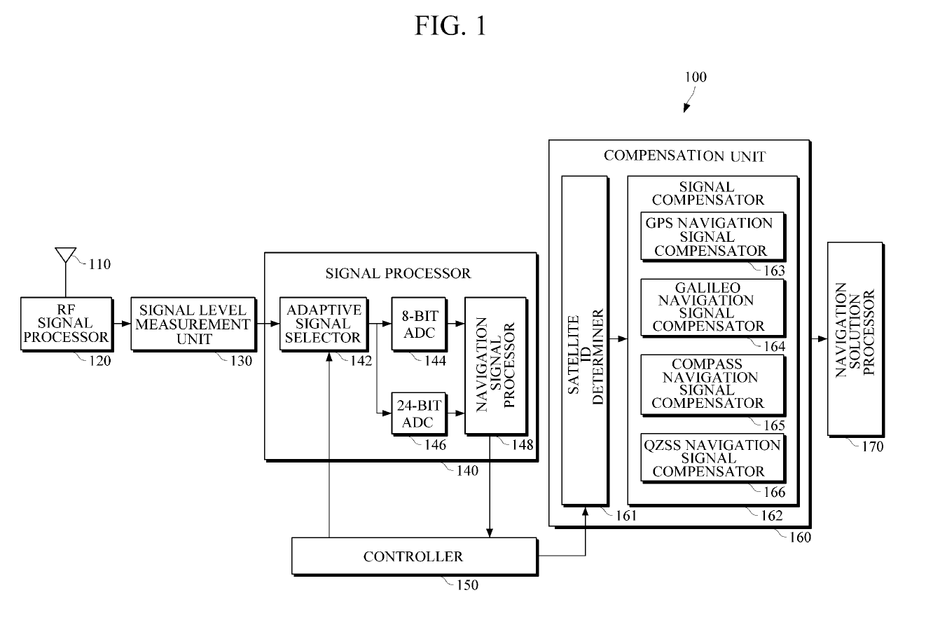

FIG. 1 is a diagram illustrating an example of a Global Navigation Satellite System (GNSS) receiver 100 for processing navigation signals adaptively.

Referring to FIG. 1, the GNSS receiver 100 includes a navigation antenna 110, an RF signal processor 120, a signal level measurement unit 130, a signal processor 140, a controller 150, a compensation unit 160, and a navigation solution processor 170. The GNSS receiver 100 may be a personal computer, a lap-top computer, a mobile phone, a smart phone, navigation, a PDA, or the like.

The GNSS receiver 100, which is used in a GNSS, is configured to receive and process navigation signals in order to quickly and efficiently utilize location information in an environment where a variety of GNSSs are available and a plurality of navigation frequencies are provided. Also, the GNSS receiver 100 is configured to cope actively with jamming signals in consideration that navigation signals are vulnerable to jamming signals.

The navigation antennas 110 may be an adaptive navigation antenna that is robust to jamming signals. The navigation antenna 110 is also configured to receive navigation signals in an environment where a variety of GNSSs are available and each GNSS provides one or more navigation frequencies. For example, the navigation antenna 110 may receive navigation signals through frequency bands L1, L2, and L6 from a GPS satellite and through frequency bands L1, L2, E1, E2, and E6 through a Galileo satellite.

The navigation antenna 110 may be configured to accept desired signals (that is, normal signals) and remove jamming signals among navigation signals. For example, the navigation antenna 110 may be an active array antenna including a plurality of antenna elements. The navigation antenna 110 may remove jamming signals using Nulling, etc., in the direction in which the jamming signals are generated, and amplify normal navigation signals, thereby improving a ratio of navigation signal to jamming signal.

The RF signal processor 120 performs frequency conversion on an RF signal processed by the navigation antenna 110 to generate an IF signal.

The signal level measurement unit 120 measures signal levels of all received navigation signals. Jamming may be Continuous Wave (CW) jamming. For example, the signal level measurement unit 130 may measure a carrier-to-noise ratio of an IF signal received through each antennal element and converted by the RF signal processor 120, as a signal level, since the carrier-to-noise ratio of a normal signal is different from the carrier-to-noise ratio of a jamming signal. Then, the signal level measurement unit 120 transfers the IF signal and the signal level to the signal processor 140.

The signal processor 140 determines whether the IF signal is a jamming signal or a normal signal based on the signal level. If the IF signal is a jamming signal, the signal processor 140 performs quantization on the jamming signal at a higher ratio than that subject to a normal signal to generate a digital signal and to perform signal processing on the digital signal. The signal processor 140 may include an adaptive signal selector 142, an 8-bit ADC 144, a 24-bit ADC 146, and a navigation signal processor 148.

The adaptive signal selector 142 may decide a processing routine for the navigation signal transferred from the signal level measurement unit 130, according to at least one of the signal level and a control signal from the controller 142. If the navigation signal is a normal signal, the adaptive signal selector 142 transfers the navigation signal to the 8-bit ADC 144 which processes signals according to a normal signal processing routine, and if the navigation signal is a jamming signal, the adaptive signal selector 142 transfers the navigation signal to the 24-bit ADC 146 which processes signals according to a jamming signal processing routine. The adaptive signal selector 142 may first transfer the navigation signal to the 8-bit ADC 144 to process the navigation signal according to the normal signal processing routine.

The 8-bit ADC 144, which performs signal processing according to the normal signal processing routine, performs 8-bit quantization on the received analog navigation signal to convert it to a digital signal.

The 24-bit ADC 146, which performs signal processing according to the jamming signal processing routine, performs 24-bit quantization on the received analog navigation signal to convert it to a digital signal. 24-bit quantization significantly lowers a ratio of broken data bits to total bits although CW jamming, etc. has occurred, compared to 8-bit quantization. Since the generation ratio of errors in all 8 bits by a certain signal is significantly higher than the generation ratio of errors in all 24 bits, 24-bit quantization is more efficient in reducing an effect by jamming than 8-bit quantization.

The navigation signal processor 148 performs navigation signal processing on the digital navigation signal obtained through quantization by the 8-bit ADC 144 or the 24-bit ADC 146. The navigation signal processing by the navigation signal processor 148 includes acquiring a signal and processing the signal. In more detail, the navigation signal processing may include acquiring a signal, accumulating a signal, extracting a pseudo range, and extracting a navigation message.

For example, the navigation signal processor 148 generates a code corresponding to a received navigation signal, and correlates the code with the navigation signal to extract satellite data including a code delay value (or code phase information), a Doppler frequency value, etc. of the navigation signal. Then, the navigation signal processor 148 may calculate a pseudo range using the satellite data. In addition, the navigation signal processor 148 performs bit synchronization, etc. on the received navigation signal, thus extracting a navigation message. The navigation message generally includes satellite times, satellite orbits, etc. Also, the navigation signal processor 148 may calculate a pseudo range change using the pseudo range.

The navigation signal processor 148 may include a plurality of navigation signal processing modules according to a GNSS type. For example, the navigation signal processor 148 may include independent processing modules for processing GPS navigation signals, Galileo navigation signals, COMPASS navigation signals, and QZSS navigation signals, respectively.

The navigation signal processor 148 may use the processing results of a kind of navigation signals in processing a different kind of navigation signals, thereby reducing a time consumed for processing navigation signals. For example, when the navigation signal processor 148 extracts a code delay value and a Doppler frequency value of a kind of navigation signal (for example, a GPS navigation signal), the navigation signal processor 148 searches for a code delay value and a Doppler frequency value of a different kind of navigation signal (for example, a Galileo navigation signal) in a predetermined range of peripheral values of the extracted code delay value and Doppler frequency value of the GPS navigation signal, thus reducing a time consumed for acquiring satellite data.

Since navigation signals have to be received from at least four or more satellites in order to acquire location information of the GNSS receiver 100, the navigation signal processor 148 can operate when navigation signals are received from at least four or more satellites. The navigation signal processor 148 transfers the results of the signal processing, that is, the pseudo range, the navigation message, etc. to the controller 150 which controls the entire operation of the GNSS receiver 100.

The controller 150 controls the adaptive signal selector 142 and a satellite ID determiner 161 based on the results of the signal processing. The controller 150 may determine whether or not the received navigation signal is a jamming signal, based on the pseudo range change. For example, if the pseudo range change is greater than a predetermined value, the controller 150 may determine that the navigation signal is a jamming signal.

If the navigation signal is a jamming signal, the controller 150 controls the adaptive signal selector 142 to select and process another navigation signal. Also, the controller 150 may extract signals in which jamming has been generated from among a variety of signals (for example, GPS, L1, L2, L5, etc.), and transfer a control signal to the adaptive signal selector 142 to process the signals in which jamming has been generated according to the jamming signal processing routine and signals in which no jamming has been generated according to the normal signal processing routine. Alternatively, the controller 150 may extract signals in which jamming has been generated from among a variety of signals, and transfer a control instruction to the compensation unit 160 to identify satellite IDs of normal signals in which no jamming has been generated and to compensate for the signals.

The compensation unit 160 includes a satellite ID determiner 161 and a signal compensator 162.

The satellite ID determiner 161 identifies satellite IDs according to which individual GNSSs are distinguished, in an environment where a plurality of GNSSs exist. The satellite ID determiner 161 may operate according to a control signal for identifying a satellite ID of a normal navigation signal in which no jamming has been generated, the control signal received from the controller 150.

The satellite ID determiner 161 may control the signal compensator 162 according to a control instruction from the controller 150 so that the signal compensator 162 can perform compensation for obtaining more accurate navigation solutions, and also the satellite ID determiner 161 may use a satellite ID to determine what GNSS a received navigation signal corresponds to and transfer the result of the determination to the signal compensator 162 so that the signal compensator 162 can perform navigation signal compensation according to the corresponding GNSS.

The signal compensator 162 is configured to compensate for navigation signals for a variety of GNSSs. The signal compensator 162 may determine whether a navigation message contains errors on a satellite link between the satellites and the GNSS receiver 100. At this time, the signal compensator 162 may use bit synchronization, frame synchronization, and error correction. In addition, the signal compensator 162 may use compensation information about a kind of navigation signals in creating compensation information about a different kind of navigation signals.

The signal compensator 162 may include a plurality of navigation signal compensators. For example, the signal compensator 162 may include a GPS navigation signal compensator 163, a Galileo navigation signal compensator 164, a COMPASS navigation signal compensator 165, and a QZSS navigation signal compensator 166. In the current example, the signal compensator 162 includes four compensator modules that compensate for four kinds of GNSS signals, however, the kind and number of compensation modules are not limited. The signal compensator 162 transfers compensation information about each GNSS signal to the navigation solution processor 170.

The GPS navigation signal compensator 163 creates compensation information about a received GPS navigation signal, the Galileo navigation signal compensator 164 creates compensation information about a received Galileo navigation signal, the COMPASS navigation signal compensator 165 creates compensation information about a received COMPASS navigation signal, and the QZSS navigation signal compensator 166 creates compensation information about a received QZSS navigation signal.

The GPS navigation signal compensator 163, the Galileo navigation signal compensator 164, the COMPASS navigation signal compensator 165, and the QZSS navigation signal compensator 166 may be configured to exchange the respective pieces of compensation information with each other. For example, the compensation information created by the GPS navigation signal compensator 163 may be transferred to the Galileo navigation signal compensator 164, the COMPASS navigation signal compensator 165, and the QZSS navigation signal compensator 166.

For example, it is assumed that a satellite ID identified by the satellite ID determiner 161 is determined to be a GPS satellite ID and the GPS navigation signal compensator 163 creates compensation information about a GPS navigation signal. In this case, if the satellite ID determiner 161 determines that a satellite ID of a newly received navigation signal is a Galileo satellite ID, the Galileo navigation signal compensator 164 can search for compensation information about the corresponding Galileo navigation signal, from peripheral values of the compensation information about the GPS navigation signal provided by the GPS navigation signal compensator 163, thereby reducing a time consumed for creating compensation information.

The navigation solution processor 170 performs error compensation based on location information, thus obtaining navigation solutions (for example, a final location, a movement speed, time information, etc.) of the GNSS receiver 100. That is, the navigation solution processor 170 may use compensation information about GPS, Galileo, COMPASS, and QZSS navigation signals to obtain a final location, a movement speed, time information, etc. of the GNSS receiver 100.

Likewise, the navigation solution processor 170 may calculate navigation solutions of a kind of navigation signals with reference to navigation solutions obtained from a different kind of navigation signals. For example, the navigation solution processor 170 may search for navigation solutions of a Galileo navigation signal, in a predetermined range of peripheral values of navigation solutions obtained from another GPS navigation signal.

The navigation solution processor 170 may provide location information obtained by the navigation solution processor 170 to an output unit such as a display (not shown) so that users can recognize their locations.

As described above, by calculating location information using the GNSS receiver 100 in an environment where a variety of GNSSs exist and a plurality of navigation frequencies are provided, navigation signal jamming due to jamming signals such as CW signals can be prevented. In addition, by exchanging information about navigation signals for various kinds of GNSSs, navigation signals can be quickly acquired. Accordingly, the GNSS receiver 100 contributes to efficient use of navigation signals in the environment where a variety of GNSSs exist, where a plurality of navigation frequencies are provided, and where CW jamming signals may be generated as navigation signals. Moreover, the GNSS receiver 100 can be effectively applied to next-generation navigation systems that will be developed in the future as well as to conventional navigation systems. In addition, the GNSS receiver 100 can support the extension of navigation signals so that users can prepare for an environment where a variety of GNSSs exist. Also, by exchanging information about different kinds of navigation signals between signal processing modules, information about a kind of navigation signals may be used to analyze a different kind of navigation signals, which reduces a time consumed for acquiring signals, thereby contributing to effective calculation of location information through a GNSS.

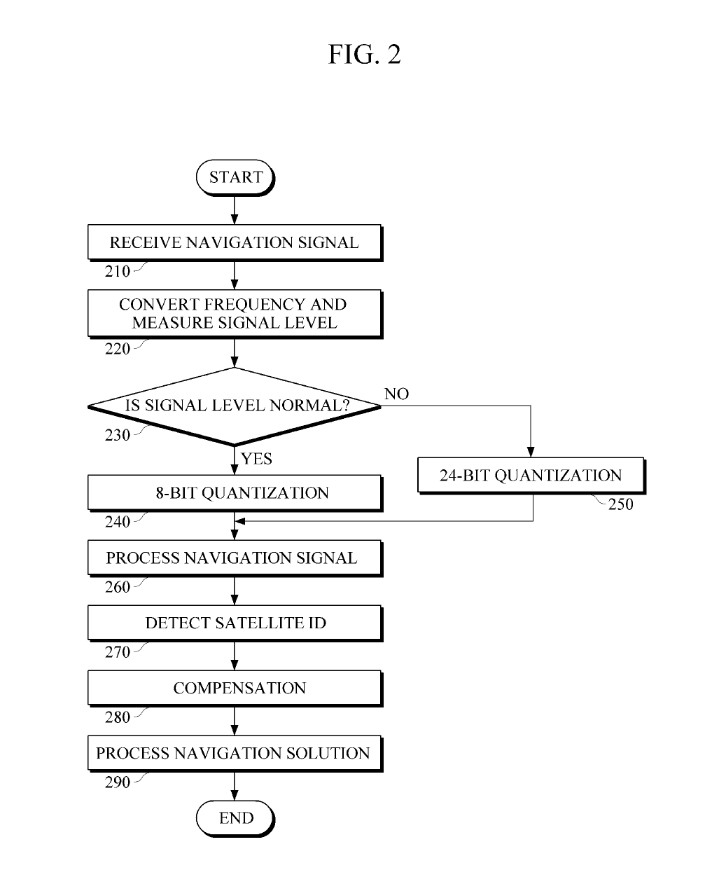

FIG. 2 is a flowchart illustrating an example of a method for processing navigation signals adaptively.

Referring to FIGS. 1 and 2, the GNSS receiver 100 receives a plurality of navigation signals from a plurality of navigation satellites (210). The navigation satellites may be different kinds of navigation satellite systems. The GNSS receiver 100 may receive the navigation signals through an active array antenna such as an adaptive navigation antenna from the plurality of navigation satellites in order to cope with jamming.

Then, the GNSS receiver 100 performs frequency conversion and signal level measurement on the received navigation signals (220).

Successively, the GNSS receiver 100 determines whether each navigation signal is a normal signal or a jamming signal, based on the measured signal level of the navigation signal (230).

If the navigation signal is a jamming signal, the GNSS 100 performs 24-bit quantization on the jamming signal (240), and if the navigation signal is a normal signal, the GNSS 100 performs 8-bit quantization on the normal signal (250).

Then, the GNSS receiver 100 performs signal processing on a digital signal obtained by the 8-bit or 24-bit quantization (260). The signal processing may include acquiring a signal, tracing a signal, and extracting a navigation message.

The GNSS receiver 100 identifies a satellite ID for the navigation signal based on the result of the signal processing (270), and creates compensation information about the individual navigation signals according to the determined satellite IDs (280).

Then, the GNSS receiver 100 calculates navigation solutions using the compensation information, thereby obtaining location information of the GNSS receiver 100 (or a user of the GNSS receiver 100) (290).

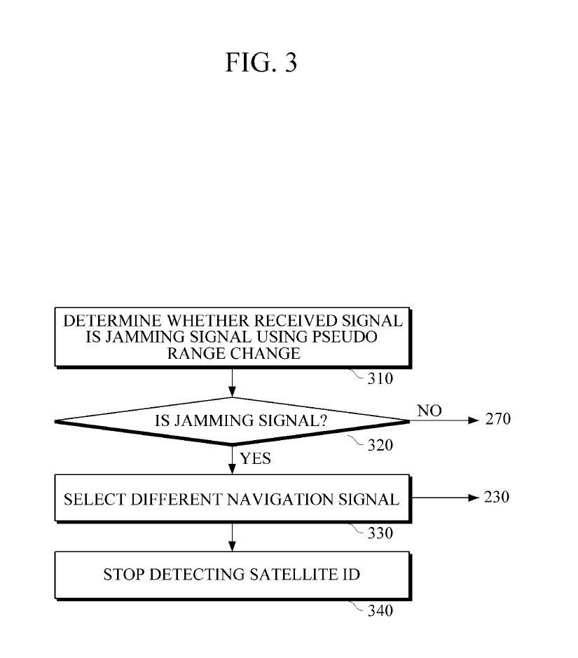

FIG. 3 is a flowchart illustrating an example of a process for controlling jamming signals.

Referring to FIGS. 1 and 3, the GNSS receiver 100 determines whether a received navigation signal is a jamming signal, based on a pseudo range change obtained in operation 260 (310).

If the received navigation signal is a normal signal, the process proceeds to operation 270 for identifying a satellite ID of the normal signal. Meanwhile, if the received navigation signal is a jamming signal, the process proceeds to operation 230 for selecting another navigation signal and again determining whether the navigation signal is a normal signal or a jamming signal. Also, if the navigation signal is determined to be a normal signal in operation 230 but to be a jamming signal in operation 320, the GNSS receiver 100 again performs 24-bit quantization on the navigation signal (250), and performs navigation signal processing on a digital signal converted by the 24-bit quantization (260).

Meanwhile, if the received navigation signal is determined to be a jamming signal (310), the GNSS receiver 100 may stop identifying a satellite ID of the jamming signal (340).

In this way, since various frequency bands of navigation signals for a variety of GNSSs are adaptively used to extend use of GNSS-based location information while coping with jamming signals in an environment where two or more GNSSs exist and a plurality of navigation frequencies are provided, the GNSS receiver can be effectively used. Also, through exchanging information about a plurality of navigation signals, the GNSS receiver can quickly acquire and process location information. Accordingly, by providing capability of quickly acquiring location information and coping actively with the use environment, the GNSS receiver can be more effectively used.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Global Navigation Satellite System (GNSS) receiver comprising:
an RF signal processor configured to receive a plurality of navigation signals from a plurality of navigation satellites;
a signal level measurement unit configured to measure a signal level of each of the navigation signals;
a signal processor configured to determine whether the navigation signal is a jamming signal or a normal signal, based on the signal level of the navigation signal, to perform, if the navigation signal is determined to be a jamming signal, quantization on the navigation signal at a higher ratio than that subject to a normal signal to generate a digital signal, and to perform signal processing on the digital signal;
a compensator configured to identify a satellite ID of the navigation signal according to the result of the signal processing, and to create compensation information about the navigation signal according to the satellite ID;
a controller configured to control the signal processor and the compensator based on the results of the signal processing by the signal processor; and
a navigation solution processor configured to calculate at least one navigation solution of the navigation signal based on the compensation information about the navigation signal.

2. The GNSS receiver of claim 1, wherein the signal processor performs, if the navigation signal is determined to be a normal signal, 8-bit quantization on the navigation signal to generate a digital signal, and performs, if the navigation signal is determined to be a jamming signal, 24-bit quantization on the navigation signal to generate a digital signal.

3. The GNSS receiver of claim 1, wherein the results of the signal processing includes a pseudo range change, and the controller determines whether the navigation signal subject to the signal processing is a normal signal or a jamming signal based on the pseudo range change, and controls, if the navigation signal is determined to be a jamming signal, the signal processor to select another navigation signal.

4. The GNSS receiver of claim 1, wherein the result of the signal processing includes a pseudo range change, and the controller determines whether the navigation signal subject to the signal processing is a normal signal or a jamming signal based on the pseudo range change, and controls, if the navigation signal is determined to be a normal signal, the compensator to identify a satellite ID of the navigation signal.

5. The GNSS receiver of claim 1, wherein if a code delay value and a Doppler frequency value of the navigation signal are extracted, the signal processor searches for a code delay value and a Doppler frequency value of another navigation signal in a predetermined range of peripheral values of the extracted code delay value and the extracted Doppler frequency value of the navigation signal, thereby reducing a time consumed for acquiring satellite data.

6. The GNSS receiver of claim 1, wherein the compensator creates the compensation information about the navigation signal with reference to compensation information about another navigation signal.

7. The GNSS receiver of claim 1, wherein the navigation solution processor calculate the navigation solution of the navigation signal with reference to at least one navigation solution obtained from another navigation signal.

8. A method of processing a satellite navigation signal, comprising:
receiving a plurality of navigation signals from a plurality of navigation satellites;
measuring a signal level of each of the navigation signals;
determining whether the navigation signal is a jamming signal or a normal signal, based on the signal level of the navigation signal, performing, if the navigation signal is determined to be a jamming signal, quantization on the navigation signal at a higher ratio than that subject to a normal signal to generate a digital signal, and performing signal processing on the digital signal;
identifying a satellite ID of the navigation signal according to the result of the signal processing, and creating compensation information about the navigation signal according to the satellite ID; and
is calculating at least one navigation solution of the navigation signal based on the compensation information about the navigation signal.

9. The method of claim 8, wherein the performing of the quantization on the navigation signal comprises, performing, if the navigation signal is determined to be a normal signal, 8-bit quantization on the navigation signal to generate a digital signal, and performing, if the navigation signal is determined to be a jamming signal, 24-bit quantization on the navigation signal to generate a digital signal.

10. The method of claim 8, wherein the result of the signal processing includes a pseudo range change, the method further comprising determining whether the navigation signal subject to the signal processing is a normal signal or a jamming signal, based on the pseudo range change.

11. The method of claim 10, further comprising:
if the navigation signal is determined to be a jamming signal, selecting another navigation signal; and
if the navigation signal is determined to be a normal signal, identifying a satellite ID of the navigation signal.

12. The method of claim 8, wherein the performing of the signal processing on the digital signal comprises searching for, if a code delay value and a Doppler frequency value of the navigation signal are extracted, a code delay value and a Doppler frequency value of another navigation signal in a predetermined range of peripheral values of the extracted code delay value and the extracted Doppler frequency value of the navigation signal, thereby reducing a time consumed for acquiring satellite data.

13. The method of claim 8, wherein the creating of the compensation information about the navigation signal comprises creating the compensation information about the navigation signal with reference to compensation information about another navigation signal.

14. The method of claim 8, wherein the calculating of the at least one navigation solution comprises calculating the navigation solution of the at least one navigation signal with reference to at least one navigation solution about another navigation signal.
